(19) United States
(12) Patent Application Publication
(10) Pub. No.: US 2015/0288773 A1
(43) Pub. Date: Oct. 8, 2015

(54) ASSOCIATING USER ACTIVITIES WITH COMMUNICATION CONNECTION SERVICES

(71) Applicant: EMPIRE TECHNOLOGY DEVELOPMENT LLC, Wilmington, DE (US)

(72) Inventor: Haruhiko Fujii, Tokyo (JP)

(21) Appl. No.: 14/646,031

(22) PCT Filed: Oct. 25, 2013
(86) PCT No.: PCT/US2013/066912

§ 371 Date: May 20, 2015

(51) Int. Cl. H04L 29/08; G06Q 20/10

(52) U.S. Cl. CPC H04L 67/22; H04L 67/141; H04L 67/16; G06Q 20/10

(57) ABSTRACT

Techniques are generally described to associate user activities with communication connection services. Example techniques may include obtaining user activity data associated with user activities in at least one online service provider, where the user activity data is associated with user identity data, and determining a communication connection service provided to a terminal device based at least in part on the user activity data.

### BACKGROUND

Online services provided via the Internet have experienced phenomenal growth in recent years. Users can purchase any products and receive services via the Internet by using their network connection devices, such as mobile devices. However, online service providers are not able to approach users who have no communication connection devices.

For those users who do have communication connection devices, communication connection providers typically offer various network connection services based on their infrastructures. Normally, users may simply determine a communication connection provider based in part on charge fees. Thus, communication connection providers attempt to differentiate their services and suggest appropriate services to users to avoid price competition with other providers.

Unless otherwise indicated herein, the materials described in this section are not prior art to the claims in this application and are not admitted to be prior art by inclusion in this section.

### SUMMARY

Example embodiments described herein include methods performed under control of a computer device that provides one or more communication connection services. By at least one example, a method may include obtaining user activity data associated with user activities in connection with at least one online service provider, wherein the user activity data is associated with user identity data, and determining a communication connection service provided to a terminal device based at least in part on the user activity data .

Example embodiments described herein also include one or more computer readable storage medium. By at least one other example, a computer readable storage medium may store contents that, when executed by a computer device, may cause the computer device to obtain user activity data associated with user activities in connection with at least one online service provider, wherein the user activity data is associated with user identity data, and determine a communication connection service provided to a terminal device based at least in part on the user activity data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram illustrating an example system to associate user activities with communication connection services;

FIG. 2 is a flowchart depicting an example method of associating user activities with communication connection services;

FIG. 3 is a flowchart depicting another example method of associating user activities with communication connection services;

FIG. 4 is a schematic diagram of an example computer readable storage medium including contents; and

FIG. 5 is a block diagram illustrating an example computing device that may be arranged to associate user activities with communication connection services, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to associating user activities with communication connection services.

Briefly stated, technologies are generally described to associate user activities with communication connection services. In some examples, a method performed under control of a computer device that provides one or more communication connection services may include obtaining user activity data associated with user activities in an online service provider, and determining a communication connection service provided to a terminal device based on the user activity data on a user-by-user basis. In some examples, determining the communication connection service may include determining the communication connection service by comparing the user activity data with one or more prescribed condition data. In some examples, providing a communication connection service based on the determination may include a communication connection service subscribed by user, an upgraded service, or a refusal of a communication connection.

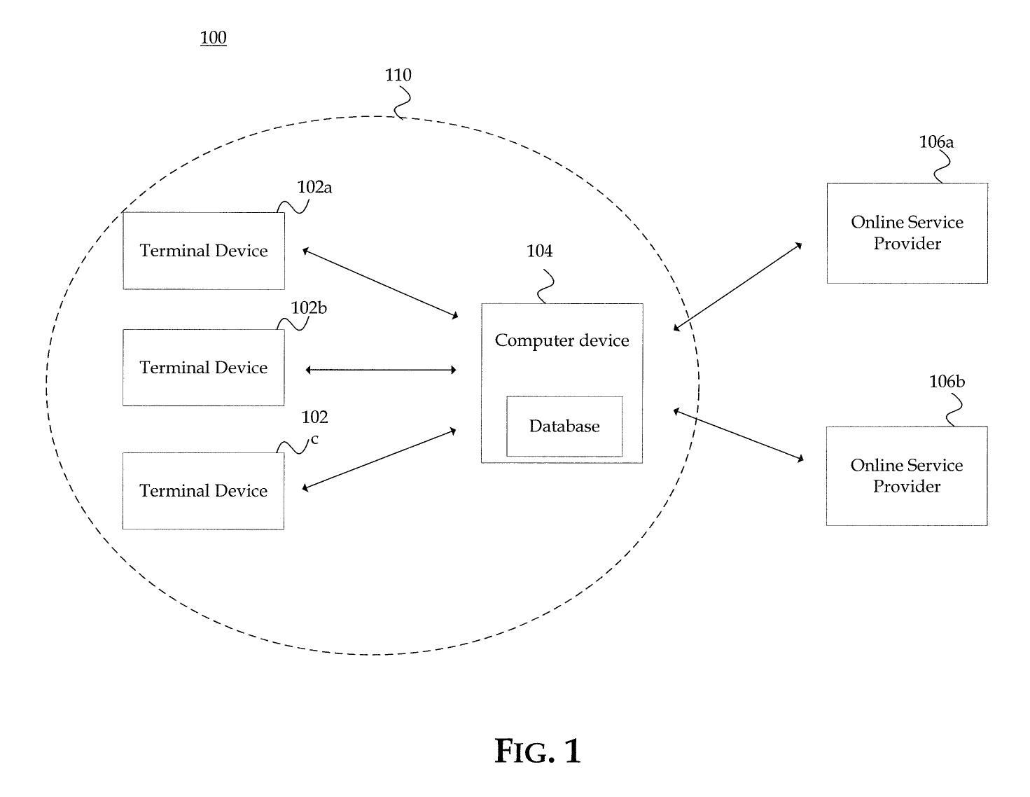

FIG. 1 is a block diagram illustrating an example system 100 in which user activities may be associated with communication connection services arranged in accordance with at least some embodiments of the present disclosure. An example system 100 may include terminal devices 102a, 102b and/or 102c, a computer device 104, and online service providers 106a and 106b. The computer device 104 may serve as a hub for a communication network 110, and allow devices, including terminal devices 102a, 102b, and 102c, to connect and communicate via the communication network 110. Examples of any of terminal devices 102a, 102b, and 102c may include, but are not limited to, a mobile phone, a smart phone, a personal digital assistant (PDA), a laptop computer, a notebook computer, an audio and/or device, a land-line phone, or other similar devices having communication capability. In some embodiments, one or more of terminal devices 102a, 102b, and/or 102c may be Wi-Fi routers that provide Wi-Fi connectivity to others of terminal devices 102a, 102b, and/or 102c that are located within a certain radius of the aforementioned terminal device that serves as a Wi-Fi router. Although three terminal devices 102a to 102c are illustrated in FIG. 1, one skilled in the art will appreciate that any number of terminal devices can be connected to the communication network 110.

In some example embodiments, a communication connection request may be sent to the computer device 104 by, or via, one or more of terminal devices 102a, 102b, and 102c. In some examples, one or more of terminal devices 102a, 102b, and 102c may communicate with one or both of online service providers 106a and 106b to implement user activities via the communication network 110. In some example embodiments, terminal devices may be associated with the communication network 110 and be registered as a user at a communication connection provider having the computer device 104. Further, as referenced herein, user activities may refer to the exchange of information or data between one or more of terminal devices 102a, 102b, and 102c, under the operation and/or control of a user. Non-limiting examples of such exchange of information or data may include online product purchases and online service purchases (e.g., digital content (e.g., music), gaming content).

In the example embodiment of FIG. 1, the computer device 104 may be configured to provide communication services, via the communication network 110, to one or more of terminal devices 102a, 102b, and 102c, and to communicate with one or both of online service providers 106a and 106b. In some examples, the computer device 104 may provide one or more communication connection services for connecting one or more of terminal devices 102a, 102b, and 102c to the Internet.

To provide a communication connection service to a terminal device, the methods described herein may be implemented by the computer device 104 having a processor and a memory. In at least one example embodiment, the computer device 104 may be configured to obtain user activity data including user identity data, and to determine a communication connection service provided to a respective one of terminal devices 102a, 102b, and 102c, based on the user activity data on a user-by-user basis. In at least one other example embodiment, the computer device 104 may be further configured to receive the user activity data from one or both of service providers 106a and 106b via the Internet. By way of example, but not limitation, the computer device 104 may have software, hardware, and/or firmware components that implement a communication network, and relevant service protocols. Some of those software components may be implemented by an operating system executing on the computer device 104. In at least one example embodiment, the user activity data may be stored in a database that may be included in or otherwise associated with the computer device 104, and the computer device 104 may reference the stored activity data when the computer device 104 activates a communication connection service. The database may store the user activity data associated with user identity data. In at least one example embodiment, the user identity data may be associated with user's payment data and user account data in an online service provider in the database. The user identity data may be a user identifier which may be based on or more of a user individual identity. In some example embodiments, payment data may be bank account information or credit card information. Examples of the bank account information may include user's bank account number, user name, and bank and branch name and bank code of the user's bank account number. Examples of the credit card information may include user's credit card number, and card company name. In some example embodiments, user account data in an online service provider can be user identifier and user password of an online service provider.

In at least one other example embodiment, a prescribed condition that may be utilized to determine a type of communication connection service to be provided to a terminal device may be stored in a memory of the computer device 104 or a storage device connected with the computer device 104. Examples of the prescribed conditions are a certain purchase amount at an online service provider, or a purchase record of a certain product or service at an online service provider.

In some example embodiments, one or both of the online service providers 106a and 106b may be configured to communicate with the computer device 104 via Internet. Thus, via one or both of online service providers 106a and 106b, at least one of terminal devices 102a, 102b, and 102c may be communicatively connected to a website by which a user of one or more of the devices may acquire products or services online. One or both of online service providers 106a and 106b may be a retailer or other business that may engage in purchase transactions or service transactions with a user of one or more of terminal devices 102a, 102b, and 102c, via the communication network 110. An example of service transactions may include, but is not limited to, an online broadcasting service, an online game service, a social networking service, an online chat service, a marketing service or any other similar services. In some embodiments, one or both of online service providers 106a and 106b may send user activity data to the computer device. Although two online service providers 106a and 106b are illustrated in FIG. 1, one skilled in the art will appreciate that any number of online service providers may be communicatively connected to the computer device 104.

The communication network 110 may be provided by a communication connection service provider including a computer device 104. Examples of the communication network 110 may include a fiber-optic network, an ADSL network, a cellular phone network, a mobile worldwide interoperability for microwave access network (WiMax), a Wi-Fi network or other similar wired or wireless network.

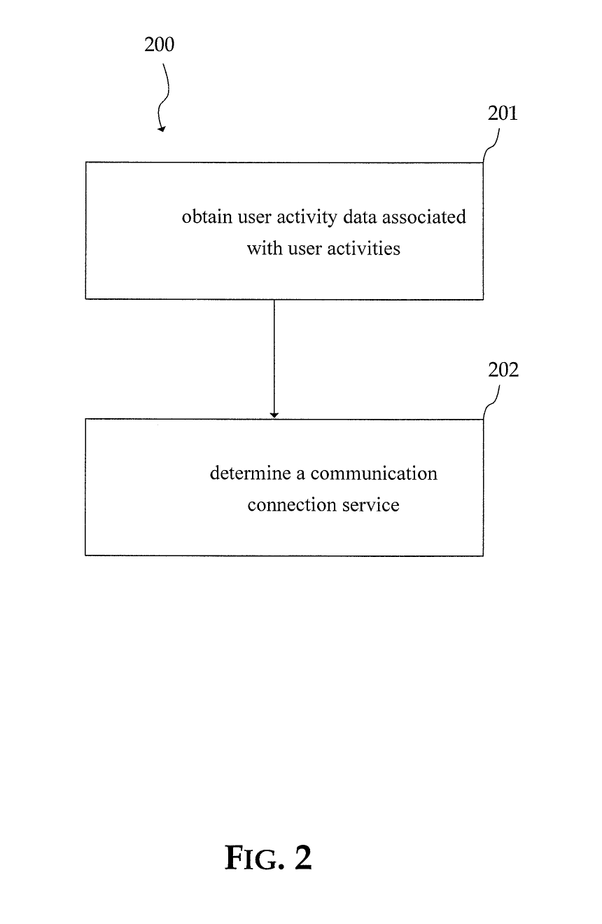

FIG. 2 is a flowchart depicting an example method 200 of associating user activities with communication connection services that is arranged in accordance with at least some embodiments of the present disclosure. Example methods 200 may include one or more operations, functions, or actions as illustrated by blocks 201 through 202. Although illustrated as discrete blocks 201 and 202, the various blocks are illustrative partitions in an example method. The example method 200 may be implemented in the example system 100, depicted in and described with reference to FIG. 1. Processing in the example method 200 may begin at block 201, which may include obtaining user activity data associated with user activities.

At block 201, the computer device 104 may be configured to obtain user activity data associated with user activities in at least one online service provider. In some example embodiments, obtained use activity data may be associated with user identity data. In one example, such obtaining may be performed by monitoring packets between a terminal device and an online service provider and reviewing packet headers. In another example, such obtaining may be performed by receiving user activity data from online service providers. In other example, obtaining may be performed by obtaining received user activity data from a database connected with or implemented in the computer device 104. Example timing of obtaining data from the database may include, but not limited to, daily, weekly, monthly, yearly, or at the time of receiving data from an online service provider. The user activity data may be associated with user activities in at least one service provider. In some embodiments, the user activity data may be associated with user identity data and/or user account data of an online service providers.

In some example embodiments, the user activity data may be associated with user identity data. In at least one example embodiment, the user identity data may be a user identifier, which may be based on one or more of a user individual identity (e.g., an identity of a user of a terminal device) or a terminal device identity (e.g., an identity of a terminal device as such), for example. Examples of a user individual identity may refer to an identity associated with a user name, a user address, a telephone number, a facsimile number, a birthday or any other data to identify a user. Examples of a terminal device identity may include a terminal production number, a Subscriber Identity Module (SIM) card number, an identifier provided from a communication connection provider (e.g., an Internet Protocol (IP) address, a WEP key, a WPA key, a Media Access Control (MAC) address). In some example embodiments, user account data in an online service provider can be user identifier and user password that are registered to one or more online service providers.

In some example embodiments, the user activity data may include purchase data or questionnaire or survey response data. The purchase data may include at least one of purchase amount data, purchase product data and purchase service data. In one example, the purchase amount data may be total purchase amount data in a certain period. In another example, purchase amount data may comprise one or more price data of purchased product and/or service data. The purchase product data and purchase service data may include detailed data regarding a product or service that the user purchased, for example. In at least one other example, the questionnaire or survey response data may include questionnaire contents which a user associated with a terminal device answered or earned reward points by answering to the questionnaire. In some example embodiments, the purchase data or questionnaire or survey response data may include a day, date, and/or time of day on which a purchase was made or a questionnaire or survey response was submitted.

In some example embodiments, the user activity data may include an amount of a cash refund based on the user activities in an online service provider. The amount of the cash refund may indicate the amount which a communication connection provider having the computer device 104 may receive from an online service provider based on the user activities via the communication network 110. The amount of the cash refund may be total amount of cash refund in a certain period of time. The amount of the cash refund to the communication connection provider may be determined by the user activities in an online service provider. In some embodiments, user activities for determining of the amount of the cash refund may be amount of the user's purchase products or services. The communication connection provider may encourage registered users to purchase products and/or services at online service providers by determining the communication connection services based on the user activities at online service providers. Instead of that, online service providers may pay a certain amount of the cash refund to the communication connection provider based on the user activities of communication connection provider users. The term “communication connection service” may refer to not only communication connection methods (e.g., broadband connection) but also additional services on communication connection (e.g., free video watching), for example. The computer device may be configured to determine a communication connection service based on obtained user activity data on a user-by-user basis.

The example method may flow from block 201 to block 202. Block 202 may include determining a communication connection. Such a determination may be performed by the computer device 104. For example, a communication connection service provided to one or more of terminal devices 102a, 102b, and 102c may be determined based at least in part on the user activity data on a user-by-user basis. The computer device 104 may be retrieved user activity data corresponding to user identity data from a database.

In some embodiments, the determination method of the communication connection service provided to one or more of terminal devices 102a, 102b, and 102c may include a determination of a communication connection service by comparing the user activity data with one or more of prescribed condition data. The computer device may determine to provide a particular communication connection service to a terminal device when user activity data corresponding to the terminal device satisfies a prescribed condition data corresponding to the particular communication connection service. When user activity data corresponding to a terminal device does not satisfy a prescribed condition data corresponding to the particular communication connection service, the computer device may determine to deny providing a particular communication connection service, or the computer device may deduct communication charge for the particular communication connection service and provide the communication connection. The term “prescribed condition data” may refer to types of data or information needed for a certain communication connection service to be provided to a user at one or more of terminal devices 102a, 102b, and 102c. The prescribed condition data may pertain to user activities, such as purchase amount information, purchase product information, purchase service, questionnaire response, and so on. Further, such user activity data in the prescribed condition may be time stamped. The prescribed condition data may correspond to communication connection services. In some example embodiments, the prescribed condition data may be changed on a moment-to-moment basis. For example, prescribed condition data may include “more than $100 of total purchase amount at the AAA online service provider in last month” to provide free broadband wireless connection in a current month. In another example, prescribed condition data may include “answered movie questionnaires at BBB online service provider” to deliver a certain movie at no charge. In other example, prescribed condition data may include a certain product and/or service purchase or a certain amount for a cash refund from a certain online service provider in a prescribed period or any other similar conditions. In other example, prescribed condition data may be information required to upgrade a communication connection service.

The computer device 104 may be configured to refer the user activity data that is stored in a database or a storage device, and compare the user activity data with one or more of prescribed condition data to determine a communication connection service. The user activity data may be associated with user identity data so that a communication connection service may be determined on a user-by-user basis.

In some embodiments, the determination method of the communication connection service may include denying providing the communication connection service if the user activity data does not satisfy the prescribed condition data to provide the communication connection service. In that case, a terminal device may not be capable to connect a communication connection service provided by a computer device.

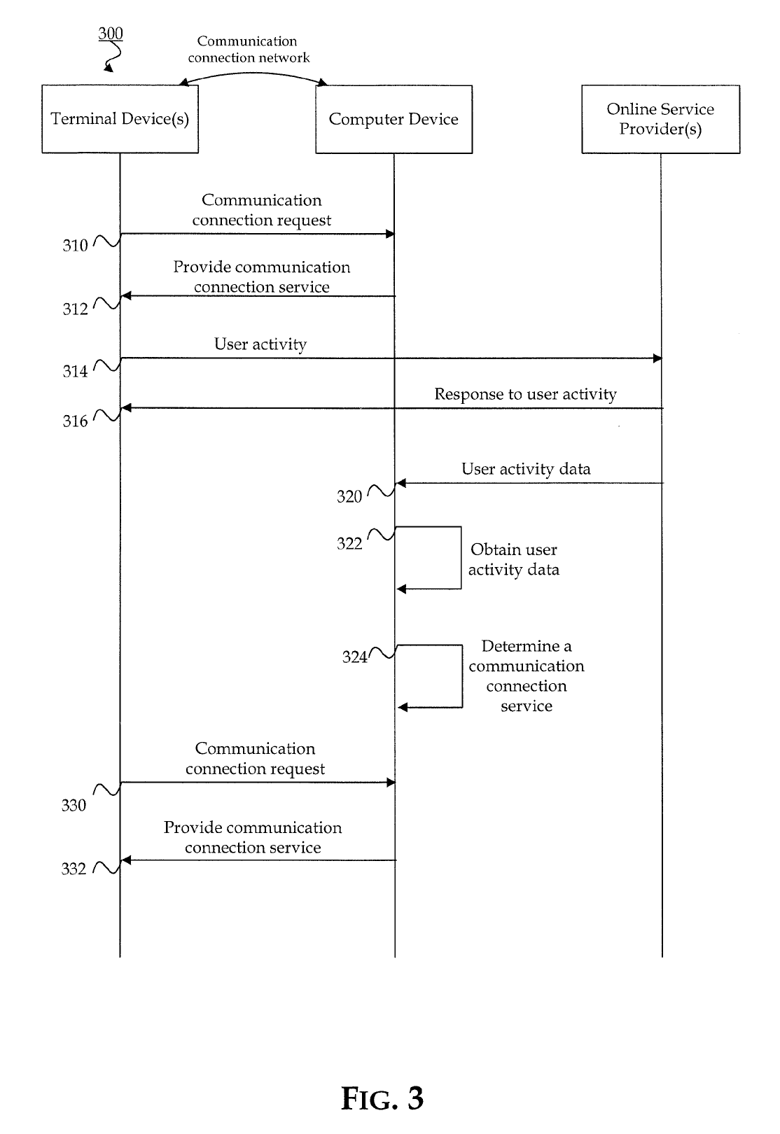

In other example embodiments, if the computer device 104 determines that the user activity data does not satisfy the prescribed condition data to provide a certain communication connection service, communication charge for a communication connection service may be deducted by a communication connection provider via a computer device. For example, a user may subscribe to a broadband service that provides free movie downloading, but prescribed condition to receive such service may exceed a prescribed purchase amount for a certain online service provider. Thus, when the user's total purchase amount does not satisfy the prescribed total purchase amount, then the computer device 104 may deduct communication charge for that service, for example. In another example, when the computer device 104 receives a refund corresponding to purchase amount of a terminal device from an online provider and the amount of the refund does not satisfy the prescribed condition for the communication connection service, the computer device may deduct deficit of communication charge corresponding to the communication connection service. The computer device may utilize payment data to deduct communication charge, for example. The payment data including bank account information or credit card information may be associated to the user identity data at a database, so that the computer device may retrieve the payment data based on the user identity data for deducting the charge. When user's total purchase amount satisfies the prescribed total purchase amount corresponding to the broadband service with free movie downloading, then a computer device may determine to provide the broadband service with free movie downloading without deducting communication charge, for example. Some additional and/or alternative example details regarding to method 200 may be discussed one or more example implementations with FIG. 3.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 is a flowchart depicting another example method 300 of associating user activities with communication connection services that is arranged in accordance with at least some embodiments of the present disclosure. Example methods 300 may include one or more operations functions, or actions as illustrated by blocks 310, 312, 314, 316, 320, 322, 324, 330, and/or 332. The example method 300 may provide one or more examples of implementations of method 200 of FIG. 2.

Method 300 may be implemented in the example system 100. One or more of online service providers 106a and 106b may be allied with a communication service provider having computer device 104, and communicate with at least one of terminal devices 102a, 102b, and 102c via communication network 110, for example. In some embodiments, in order to register a user of a one of terminal devices 102a, 102b, and 102c with one or more allied online service providers, computer device 104 may send payment data associated with user identity data to one or both of online service providers 106a and 106b. The payment data may be credit card information, bank account information, or any other similar information regarding to the payment. In some example embodiments, the computer device 104 may receive user account data of the online service provider in response to sending payment data. For example, received user account data may be associated with the user identity data. In one example, user account data may include a user identifier in an online service provider, or information to log-in an online service provider. In at least one example, a computer device may store payment data and/or user account data associated with user identity data at a database.

The example method 300 may begin at 310 (communication connection request) at which computer device 104 may receive a communication connection request from one or more of terminal devices 102a, 102b, and 102c. For example, at least one of terminal devices 102a, 102b, and 102c may send a communication connection request to computer device 104 when accessing one of online service providers 106a and 106b via communication network 110. In at least one other example embodiment, at least one of terminal devices 102a, 102b, and 102c may send a user ID and a password for authentication to computer device 104 together with a communication connection request. In another example embodiment, one or more of terminal devices 102a, 102b, and 102c may send a communication connection request with user identity data.

The example method 300 may flow from 310 to 312 (provide communication connection service) at which computer device 104 may provide a communication connection service to one or more of terminal devices 102a, 102b, and 102c in response to the communication connection request. In some embodiments, computer device 104 may provide a communication connection service which is determined based on user activity data corresponding to one or more of terminal devices 102a, 102b, and 102c. In another example, instead of determined communication connection service based on user activity data, computer device 104 may provide a communication connection service which is subscribed to by a user of one or more of terminal devices 102a, 102b, and 102c. In that case, user activity data corresponding to the user of the terminal device may not exist, or a communication connection request may be received within a certain period from starting the subscription, for example.

The example method 300 may flow from 312 to 314 (user activity) at which one or more of terminal devices 102a, 102b, and 102c may send data regarding to use activities to an appropriate one of online service providers 106a and 106b via a communication connection network. The user activity may include product purchase, online content subscription, responding to a questionnaire or survey, or any other similar activities that may be provided by an online service provider.

The example method 300 may flow from 314 to 316 (response to user activity) at which an online service provider may send a response to a user activity to one or more of terminal devices 102a, 102b, and 102c, via communication connection network 110. The response may include any confirmations of user activities, such as a purchase, subscription, or a response to a questionnaire or survey, for example.

The example method 300 may flow from 316 to 322 (obtain user activity data) at which computer device 104 may obtain user activity data by monitoring packets between one or more of terminal devices 102a, 102b, and 102c and one or both of online service provider 106a and 106b, and reviewing packet headers, for example. The user activity data may be associated with user identity data, and/or time data.

In another example, method 300 may optionally flow from 316 to 320 (user activity data) at which computer device 104 may receive user activity data from one or both of online service providers 106a and 106b. Such user activity data may include purchase data, questionnaire or survey response data, or a refund amount. The user activity data may be received at any time from one or both of online service providers 106a and 106b. In one example, user activity data may be associated with user account data of one of online service providers 106a and 106b, time data, and/or user identity data. In this case, at 322, computer device 104 may obtain user activity data without monitoring packets.

The example method 300 may flow from 322 to 324 (determine communication connection service) at which computer device 104 may determine a communication connection service provided to one or more of terminal devices 102a, 102b, and 102c based on obtained user activity data. In one example, such a determination may include comparing user activity data with one or more of prescribed condition data. In some example embodiments, if the user activity data does not satisfy the prescribed condition data to provide a certain communication connection service, computer device 104 may deny a communication connection service to one of terminal devices 102a, 102b, and 102c upon which the user is logged on or over which the user exercises control. In other example embodiments, if computer device 104 determines that the user activity data does not satisfy the prescribed condition data to provide a certain communication connection service, communication charge for a communication connection service may be deducted by a communication connection provider via computer device 104.

The example method may flow from 324 to 330 (communication connection request) at which computer device 104 may again receive a communication connection request from one or more of terminal devices 102a, 102b, and 102c. 330 may be the same as 310, for example.

The example method may flow from 330 to 332 (provide communication connection service) at which computer device 104 may provide a communication connection service, and one or more of terminal devices 102a, 102b, and 102c may connect to communication network 110. The determined communication connection service at 324 may be provided to one or more of terminal devices 102a, 102b, and 102c. This may be the same as 312, for example.

310-332 may represent one type of transaction facilitated by computer device 104.

In some example embodiments, the example method may flow from 310 or 330 to 322, at which obtaining user activity data at computer device 104 may be performed after receiving a communication connection request from a one or more of terminal devices 102a, 102b, and 102c. In such a case, computer device 104 accesses a database that stores user activity data associated with user identity data, and may further refer to user activity data corresponding to one or more of terminal devices 102a, 102b, and 102c which sent the communication connection request. The example method may flow from 322 to 324, at which computer device 104 may determine a communication connection service. 324 may be followed by 312 or 332 (provide communication connection service).

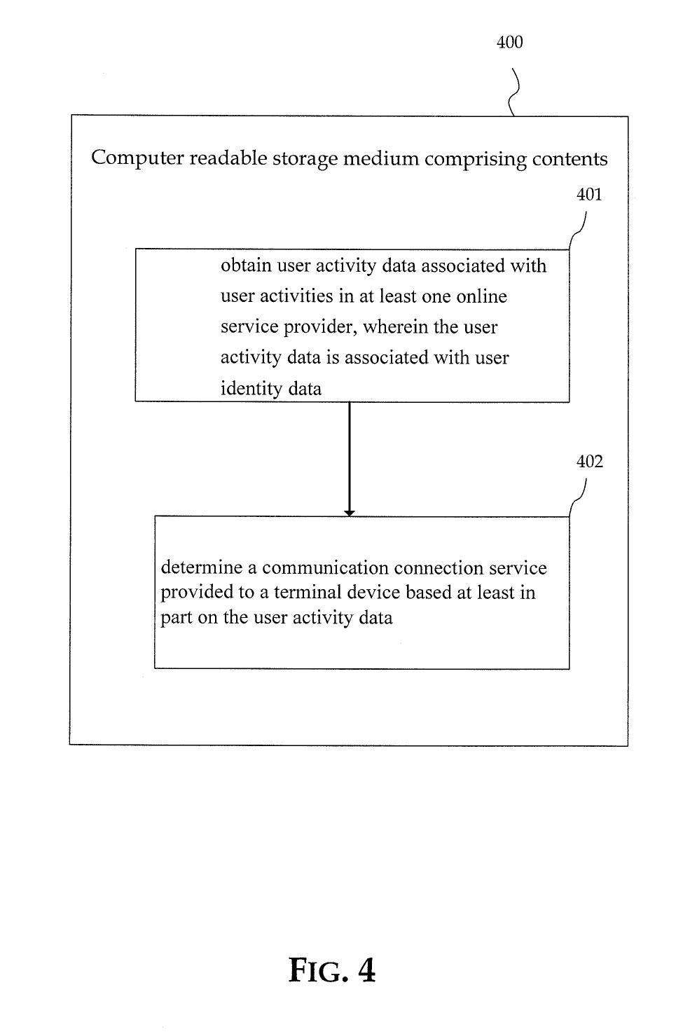

FIG. 4 is a schematic diagram of an example computer readable storage medium 400 including contents arranged in accordance with at least some embodiments of the present disclosure. When executed by a computer, contents of the computer readable storage medium may cause the computer to obtain user activity data associated with user activities in at least one online service provider, wherein the user activity data is associated with user identity data (operation 401); and determine a communication connection service provided to a terminal device based at least in part on the user activity data on a user-by-user basis (operation 402).

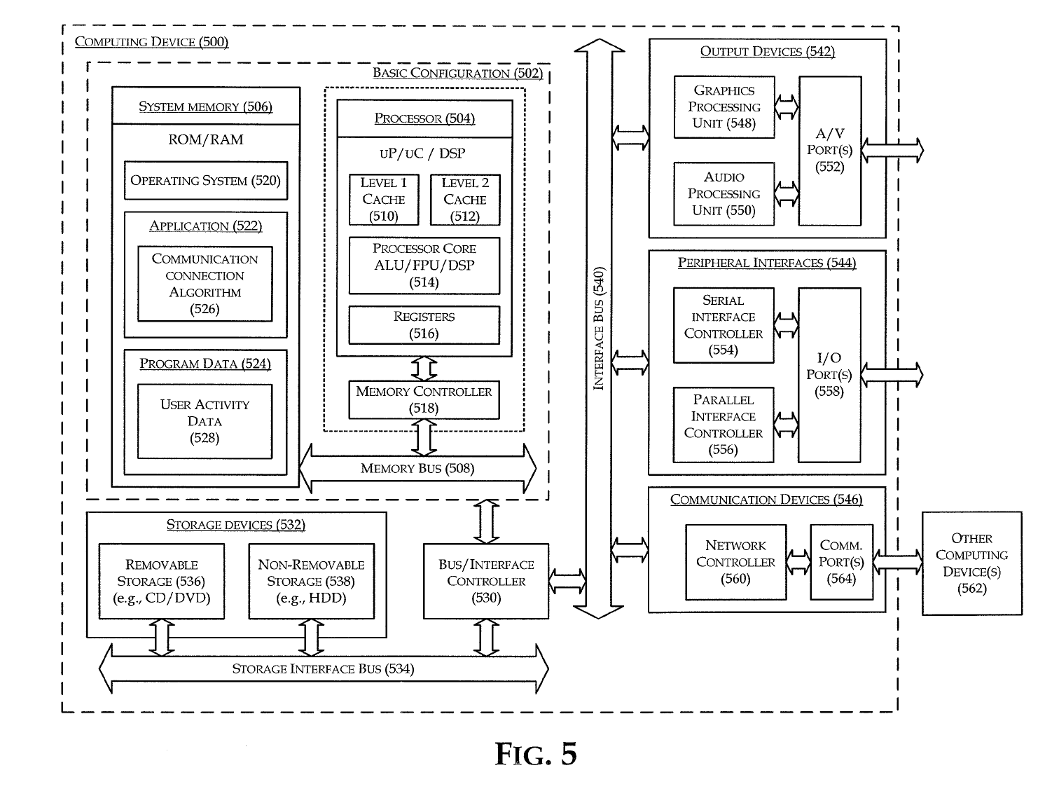

FIG. 5 is a block diagram illustrating an example computing device 500 that is arranged for providing one or more communication connection services in accordance with the present disclosure. In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524. Application 522 may include a communication connection algorithm 526 that is arranged to perform the functions as described herein including the functional blocks and/or actions described with respect to process 200 of FIG. 2 and/or process 300 of FIG. 3. Program data 524 may include user activity data 528 that may be useful for determining a communication connection service as is described herein. In some embodiments, application 522 may be arranged to operate with program data 524 on operating system 520 such that implementations of determination of a communication service may be provided as described herein. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a computer device providing one or more communication connection services, comprising:
obtaining user activity data associated with user activities in connection with at least one online service provider, wherein the user activity data is associated with user identity data; and
determining a communication connection service provided to a terminal device based at least in part on the user activity data-.

2. The method of claim 1, wherein the determining the communication connection service comprises determining the communication connection service by comparing the user activity data with one or more of prescribed conditions.

3. The method of claim 1, further comprising:
receiving the user activity data from at least one online service provider.

4. The method of claim 1, wherein the user identity data includes at least one of a user individual identity or a terminal device identity.

5. (canceled)

6. (canceled)

7. (canceled)

8. (canceled)

9. The method of claim 2, further comprising:
deducting a communication charge for provision of a communication connection service if it is determined that user activity data does not satisfy the prescribed conditions to provide the communication connection service.

10. The method of claim 2, wherein the determining the communication connection service further comprises denying providing the communication connection service if the user activity data does not satisfy the prescribed condition data to provide the communication connection service.

11. The method of claim 1, further comprising:
receiving a communication connection request from a terminal device; and
providing a communication connection service based on the determination in response to the communication connection request.

12. The method of claim 1, further comprising:
sending payment data associated with user identity data to at least one online service provider; and
receiving user account data of the online service provider, wherein the user account data is associated with the user identity data.

13. The method of claim 1, wherein the communication connection service is a broad-band connection service.

14. The method of claim 2, wherein the prescribed condition is purchase amount information, purchase product information, or purchase service information for a communication connection service to be provided to the terminal device.

15. A non-transitory computer readable storage medium storing computer-executable instruction that, when executed, cause one or more processors to:
obtain user activity data associated with user activities in connection with at least one online service provider, wherein the user activity data is associated with user identity data; and
determine a communication connection service provided to a terminal device based at least in part on the user activity data.

16. The computer readable storage medium of claim 15, wherein determining the communication connection service comprises determining the communication connection service by comparing the user activity data with one or more of prescribed condition data.

17. The computer readable storage medium of claim 15, when executed by the computer device, further cause the computer device to: receive the user activity data from at least one online service provider.

18. The computer readable storage medium of claim 15, wherein the user identity data is based on one or more of a user individual identity or a terminal device identity.

19. (canceled)

20. (canceled)

21. (canceled)

22. (canceled)

23. The computer readable storage medium of claim 16, when executed by the computer device, further cause the computer device to:
deduct communication charge for a communication connection service if it is determined that user activity data does not satisfy the prescribed condition data to provide the communication connection service.

24. The computer readable storage medium of claim 16, wherein the determining the communication connection service further comprises: denying providing the communication connection service if the user activity data does not satisfy the prescribed condition data to provide the communication connection service.

25. The computer readable storage medium of claim 15, when executed by the computer device, further cause the computer device to:
receive a communication connection request from one of terminal devices; and
provide a communication connection service based on the determination in response to the communication connection request.

26. The computer readable storage medium of claim 15, when executed by the computer device, further cause the computer device to:
send payment data associated with user identity data to at least one online service provider; and
receive user account data of the online service provider wherein the user account data associated with the user identity data.

27. The computer readable storage medium of claim 15, wherein the communication connection service is a broad-band connection service.

28. The computer readable storage medium of claim 16, wherein the prescribed condition is purchase amount information, purchase product information, or purchase service information for a communication connection service to be provided to the terminal device.
